(19) United States
(12) Patent Application Publication
(10) Pub. No.: US 2010/0057337 A1
(43) Pub. Date: Mar. 4, 2010

(54) SYSTEM AND METHOD FOR PROVIDING DIGITAL MAP, ROUTING, OR NAVIGATION INFORMATION WITH NEED-BASED ROUTING

(75) Inventor: Gil Fuchs, Woodside, CA (US)

Correspondence Address: FLIESLER MEYER LLP, 650 CALIFORNIA STREET, 14TH FLOOR, SAN FRANCISCO, CA, 94108, US

(73) Assignee: TELE ATLAS NORTH AMERICA, INC., Lebanon, NH (US)

(21) Appl. No.: 12/203,061

(22) Filed: Sep. 2, 2008

(51) Int. Cl. G01C 21/00; G06Q 30/00

(52) U.S. Cl. 701/200; 701/213

(57) ABSTRACT

A system and method for providing digital map or navigation information with need-based routing. In accordance with an embodiment, the system disclosed herein provides a means for suppliers, such as suppliers or retailers of goods and services, to provide information about the availability of those goods and services. When a user interacts with the system and a need is determined, the system can offer information, such as directing the user to an appropriate supplier, including where appropriate a map and/or route to the supplier. In accordance with an embodiment the system can take into account the user's location, and/or the supplier's locations, and/or a cost associated with an item, and/or other geographic and non-geographic information that can be stored and retrieved from a digital map or a supplier.

### CROSS-REFERENCE TO RELATED APPLICATIONS

This application is related to co-pending patent application entitled “A METHOD AND SYSTEM FOR CREATING UNIVERSAL LOCATION REFERENCING OBJECTS”; Inventor: Gil Fuchs; application Ser. No. 11/271,436; filed Nov. 10, 2005, and incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

The invention is generally related to digital maps, navigation, and systems for searching, and is particularly related to a system and a method for providing need-based routing in a map or other search environment.

### BACKGROUND

Traditional paper maps have been largely superseded by digital maps and electronic databases which can be updated as desired, and which are able to respond to a wide of operator input and produce a correspondingly wide range of operator-requested output. Many electronic documents in common use today also comprise information that relates to geographic locations. An additional benefit of digital maps over traditional paper maps is the inherent ability of a digital map to store and portray large amounts of data. Paper maps are comparatively limited in the amount and type of information they can portray, within the constraints of their physical formats, and are also difficult to update.

While early versions of digital maps seemed merely like a scanned version of the prior paper product, modern digital maps are more powerful. Information can be included in the map, and can be subsequently either displayed or hidden, depending on the wishes of the operator. Today's digital maps also allow for regular modification of the data points included in the map. Some currently available digital maps also allow for linking between, say, a text address and its location on the map. If an operator inputs a street address into a Yahoo! Maps software application, a Google map, MapQuest, or a similar Internet mapping website, then the output can indicate the location of that particular address on a map, together with useful information, such as restaurants, parking facilities, and other types of services.

However, current applications of digital maps are limited in the manner in which they provide such information. Generally, a user must know which service they are looking for, and also have a sense as to which types of location might provide that service. The map can then be used to locate appropriate locations. For example, a user desiring to purchase a coffee drink late in the evening might know that Starbucks cafes sell such coffee drink, that some Starbucks are open late in the evening, and that there is a good chance of finding a Starbucks in a particular area. With the benefit of this knowledge the user can search within the map to initially find coffee shops, perhaps then focusing their search on particular chains, or opening times. They may eventually find one or more Starbucks locations to try, and can visit that location to determine if their coffee drink is available. However, this approach assumes an inherent knowledge on the part of the user as to what they are looking for, and does not inform the user whether an actual product or service will ultimately be available. These are some of the general areas that embodiments of the present invention are designed to address.

### SUMMARY

Described herein is a system and method for providing digital map or navigation information with need-based routing. In accordance with an embodiment, the system disclosed herein provides a means for suppliers, such as supplier or retailers of goods and services, to provide information about the availability of those goods and services. When a user interacts with the system and a need is determined, the system can offer information, such as directing the user to an appropriate supplier, including where appropriate a map and/or route to the supplier. In accordance with an embodiment the system can take into account the user's location, and/or the supplier's locations, and/or a cost associated with an item, and/or other geographic and non-geographic information that can be stored and retrieved from a digital map or a supplier. Using this method, the system can provide a more integrated map or navigation experience for the user.

### BRIEF DESCRIPTION OF THE FIGURES

FIG. 1 is an illustration that shows a system for need-based routing in accordance with an embodiment.

FIG. 2 is an illustration of a typical user-system interaction with a need-based routing system in accordance with an embodiment.

FIG. 3 is another illustration of a system for need-based routing in accordance with an embodiment.

FIG. 4 is an illustration that shows an alternative system for need-based routing in accordance with an embodiment.

FIG. 5 is an illustration that shows an alternative system for need-based routing in accordance with an embodiment.

FIG. 6 is an illustration that shows an alternative system for need-based routing in accordance with an embodiment.

FIG. 7 is an illustration that shows an alternative system for need-based routing in accordance with an embodiment.

FIG. 8 is a flowchart of a method for need-based routing in accordance with an embodiment.

FIG. 9 is a flowchart of an alternative method for need-based routing, which uses a centralized, distributed or static database, in accordance with an embodiment.

FIG. 10 is a flowchart of an alternative method for need-based routing, which uses dynamic data communication, in accordance with an embodiment.

### DETAILED DESCRIPTION

As described above, current applications of digital maps are limited in the manner in which they provide such information. Generally, a user must know which service they are looking for, and also have a sense as to which types of location might provide that service. The map can then be used to locate appropriate locations. However, this approach assumes an inherent knowledge on the part of the user as to what they are looking for, and does not inform the user whether an actual product or service will ultimately be available.

Described herein is a system and a method for providing need-based routing in a map environment. In accordance with an embodiment, the system disclosed herein provides a means for suppliers, such as suppliers or retailers of goods and services, to provide information about the availability of those goods and services. When a user interacts with the system and a need is determined, the system can offer information, such as directing the user to an appropriate supplier, including where appropriate a map and/or route to the supplier. In accordance with an embodiment the system can take into account the user's location, and/or the supplier's locations, and/or a cost associated with an item, and/or other geographic and non-geographic information that can be stored and retrieved from a digital map or a supplier. Using this method, the system can provide a more integrated map or navigation experience for the user. For example, the system can provide a map with precise locations and routing to, say, coffee shops that are open at a particular time close to a particular destination and that offer a particular type of drink. The system can also act as a clearinghouse for suppliers of goods and services to ensure that their company and its products are promoted as suitable choices to users searching for them.

### GLOSSARY OF TERMS

The following section defines some of the terms used in the context of this document:

Digital Map Provider—A commercial, governmental, or other type of entity or company which develops, maintains, and provides a file-of-reference or digital base map, or supplies the data that comprises a file-of-reference or digital base map. Digital map providers can also act as third-party file providers in certain instances.

Third-Party—A third-party, third-party data supplier, or third-party data source is a commercial, governmental, or other type of entity, usually separate from the digital map provider, that provides third-party data for use with the file-of-reference or digital base map.

Supplier—A party that provides availability and/or cost data for one or more products or services. In accordance with an embodiment a supplier can also be third-party.

File-of-Reference—A geospatial database, data structure, document, or digital map used for permanent storage of a document owner's geographic data.

Third-Party File—A geospatial database, data structure, document, or digital map used for storage of the owner's geographic or other data.

Virtual Database/Virtual Database System—A means of treating data distributed over multiple databases as if they belonged to a single database.

Virtual Map—An interim database, or in some instances the output of a virtual database.

ULRO—In those embodiments that utilize a universal location record object (ULRO), a permanent identification code and sufficient information designed to uniquely identify a particular location within a file-of-reference or third-party file. A location, in turn, can be associated with one or more geographic items. ULROs can be employed to establish traversable links between the file-of-reference and the third-party-files for a broad range of database formats. ULROs can be similarly employed to establish traversable links between two or more third-party files.

Map—A generic term that is used to refer to a geospatial database, digital map, or the map data contained therein.

Map Object—A map item, or more appropriately a data object instantiated within a geospatial database or map.

Feature/Geographic Feature—An idealized map representation of an actual object from the real world, which is useful to that map representation. Features can have a dimension, and most often but not always have geometric representations. Features might not be actually visible in the real world: such as borders or intersections, yet notwithstanding this they can still be represented in a map model.

Location—The location is where a feature is in the real world, which is a distinct concept from the feature itself. For example, while a feature may be a particular restaurant, its location can be specified as some latitude, longitude (lat/long) coordinate pair, or coordinates from some similar geodetic referencing system, or as a human readable address, (for example “322 Battery Street in San Francisco”). Locations should not be confused with features, or with the other geographic items associated with the locations.

Point of Interest—A special type of point feature. In particular, the POI is a feature type that can comprise other, more specific types, such as a restaurant, hotel, or museum.

Additional information about the use of ULRO and each of the other items listed within the above glossary, is provided in copending U.S. patent application “A METHOD AND SYSTEM FOR CREATING UNIVERSAL LOCATION REFERENCING OBJECTS”; Inventor: Gil Fuchs; application Ser. No. 11/271,436; filed Nov. 10, 2005, and incorporated herein by reference.

In accordance with an embodiment, a user, supplier, place of interest (POI) goods, or service can be identified using a location identifier, such as a latitude/longitude (lat/long) attribute. In accordance with some embodiments, the system can use a universal location referencing object (ULRO) that uniquely corresponds to the location. Other geographic schemes and attributes can be used. The lat/long, ULRO, or other geographic attribute can then be used to support need-based routing in an electronic or digital map environment. In a traditional digital map, it is possible to map a route from one location to another. Similarly, it is possible to map a route from a starting location to a particular type of location or point of interest (POI). Embodiments of the present invention add another dimension, namely the ability to map a route based on a particular need, for example the need to find a particular type of food; or the need to see a particular movie playing at various movie theaters. Need-based routing is particularly useful for a user's shopping needs. For example, a user may be driving, with no accurate information as to where he or she is. The user may, as an example, need to find office staples for use in the user's staple gun. In this scenario the user needs to know where staples can be found at that particular time, and as reasonably accessible to the user's location as possible. In embodiments that include cost data, describing the cost of a particular goods or services at different suppliers, the system can route the user to the most cost-effective location that satisfies their need. When driving, the system can also take into account such parameters as distance (which can determine fuel usage), in determining the most appropriate route for the user.

In accordance with an embodiment (and as reflected in many day-to-day situations) the most accessible location to acquire a goods or service may not necessarily be the geographically nearest location. For example, a first outlet for office staples may require the crossing of a busy highway, while another outlet that is a half-mile farther away can be reached with ease and is therefore preferable. In accordance with an embodiment, the actual results that are returned to the user will depend on a range of information, potentially including the locations and opening hours of different stores, cost information, levels of service at different stores, attributes of the desired item, the stock of different stores in the item, brands offered, colors offered, sizes offered, and so on.

In accordance with some embodiments, a “needs-satisfaction” information comprises information on availability and/or cost of at least one of a service or a product. The needs-satisfaction information can comprise information about locations offering at least one of a service and a product. According to further embodiments, the needs-satisfaction information can comprise information about cost of the at least one of a service and a product. According to still further embodiments, the needs-satisfaction information can comprise information about the times of availability of the at least one of a service and a product.

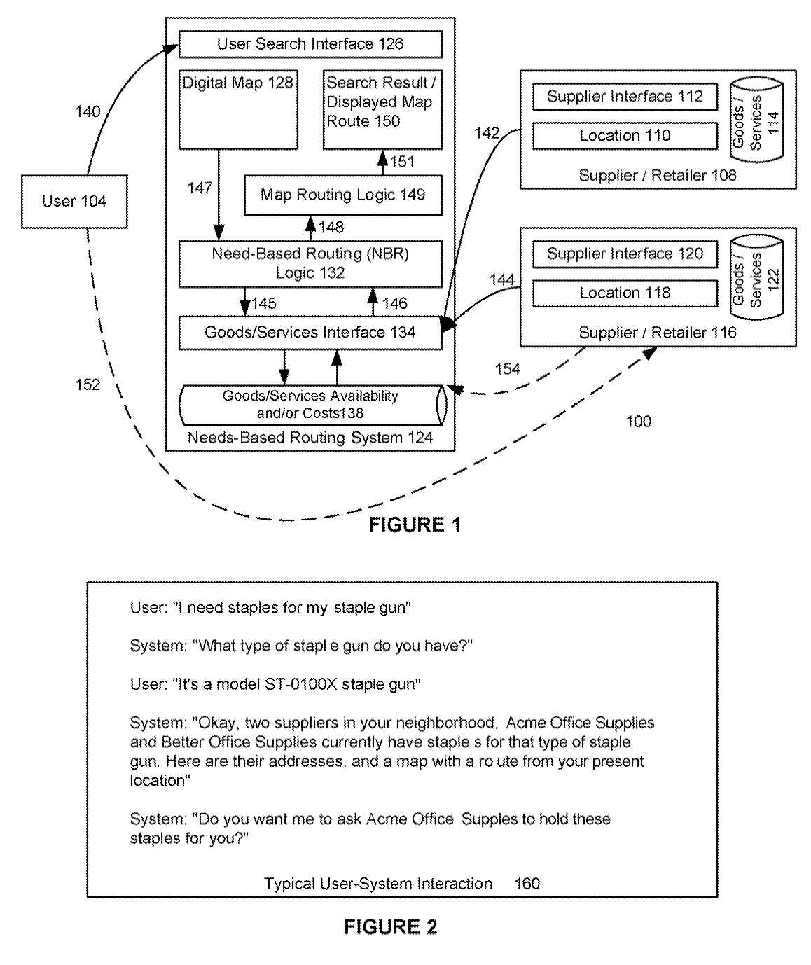

FIG. 1 is an illustration that shows a system for need-based routing in accordance with an embodiment. In accordance with an embodiment 100, a need-based routing system 124 allows a user 104 to receive information and locate suppliers of goods and services that can satisfy a particular need. In accordance with an embodiment, each supplier or retailer 108, 116 has a location information 110, 118 associated therewith. This information can be in the form of a lat/long, ULRO, or other type of location-related information. Depending on the particular implementation, a supplier or retailed may have many different locations associated therewith, corresponding to different outlets or stores, service locations, product locations, or other locations that are important to that supplier or the goods and services it provides. Each supplier can maintain its own information 112, 114, including availability and/or cost data about the goods and services provided by that supplier. Each supplier also provides or allows access to a supplier interface 112, 120, which the system uses to receive goods and services availability information from the supplier, and optionally to provide requests from users for those goods and services. In accordance with an embodiment, the need-based routing system 124 can be located on a server or at a central or distributed location, and includes a user search interface 126 for receiving requests from users. A goods/services interface 134 allows the system to receive needs-satisfaction information from suppliers and retailers that describes the availability of goods and services at those suppliers and retailers. In accordance with an embodiment, the system further comprises a digital map 128 and a need-based routing (NBR) logic 132. Optionally, the system can comprise a centralized database of goods/services availability and/or cost data 138, which stores information about the goods and services availability at the suppliers and makes that information available via the goods/service interface. When a request or query 140 is received from a user, the NBR logic 132 queries 145 and/or uses the information 146 received from the goods/services interface, together with information 147 received from the digital map to translate a user's need to an offered product or service, and to determine availability of goods and/or services to satisfy the users need, taking into account any geographic or other requirements the user may have specified, or that may be reasonably implied. In accordance with other embodiments, described in further detail below, the goods/service interface can also provide access to goods or service information stored at each of the suppliers, rather than at the needs-based routing system itself. Depending on the particular implementation the information describing availability of goods and/or services to satisfy the users need can be provided 148 to a map routing logic 149 for determination of an appropriate map route 151. The result, including in some embodiments a digital map and/or a displayed map route 150, or other route information such as text-based directions, is then provided to the user. In accordance with an embodiment, the user can optionally request that the system communicate a request 152 to one or more suppliers to hold the goods or services needed by the current user and current request. The system can then communicate 154 with the supplier to update the availability of goods and services for that supplier, to reflect any user-requested hold on those goods or services.

Although not shown in FIG. 1, in accordance with an embodiment the system can typically include a computing device which in turn comprises one or more memories, one or more processors, and one or more storages or repositories of some sort. The system can further include a display device, including a graphical user interface or GUI operating thereon by which the system can display digital maps and other information.

FIG. 2 is an illustration of a typical user-system interaction with a need-based routing system in accordance with an embodiment. As shown in FIG. 2, in those embodiments that use a questionnaire format (for example a Web page that provides user input and response), the system can prompt a user for a specific need, or allow a user to enter a free-form search. The system can then use standard search-parsing techniques, in combination with information received from the suppliers through the goods/service interface, to determine the user's need and the suppliers that can likely satisfy that need. In the example shown in FIG. 2, the user can enter a text search string such as:
User: “I need staples for my staple gun”
   To which the system may respond:
System: “What type of staple gun do you have?”
   The user/system dialog may continue until the system has enough information to determine the user's need, and the supplier that is likely to be able to satisfy that need:
User: “It's a model ST-0100X staple gun”
System: “Okay, two suppliers in your neighborhood, Acme Office Supplies and Better Office Supplies currently have staples for that type of staple gun. Here is their address information, and a map with a route from your present location”
   In accordance with some embodiments that utilize two-way communication, the system can allow a user to place a hold or other request for a needed goods or service:
System: “Do you want me to ask Acme Office Supplies to hold these staples for you?”
   If the user responds yes to this question, then the system can inform the supplier (in this instance ask Acme Office Supplies), that a user has been routed to their location, and that they should hold the goods or service for them (subject to that supplier's policy of accepting holds in such a manner).

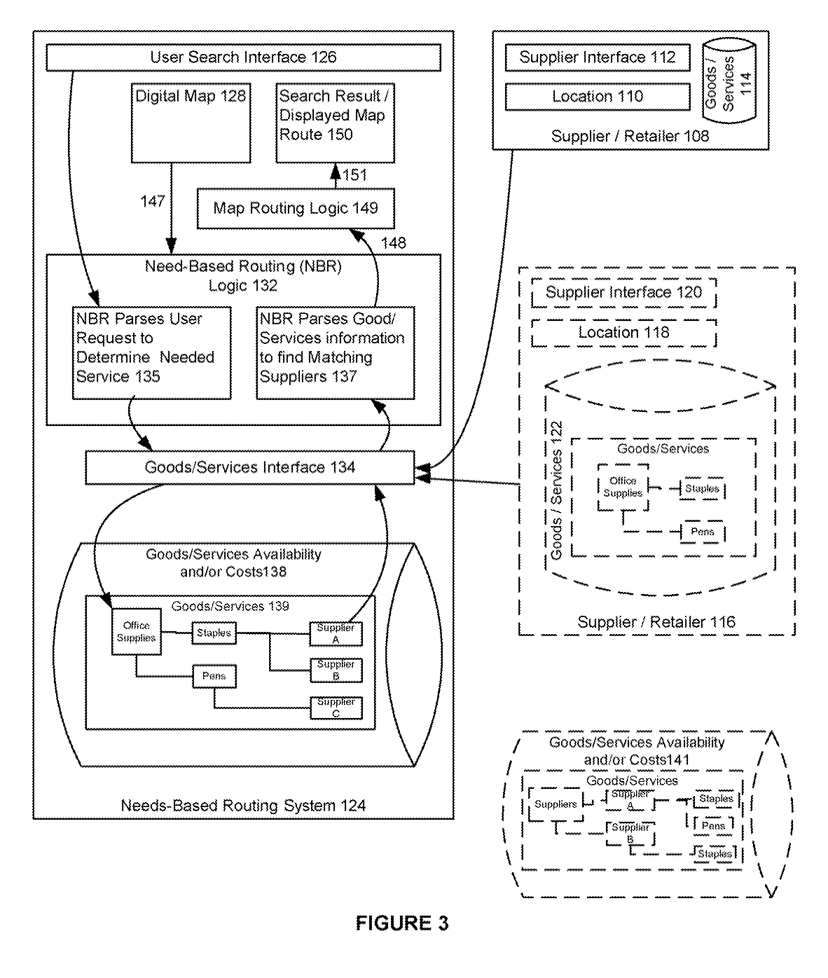

FIG. 3 is another illustration of a system for need-based routing in accordance with an embodiment. As described above, in accordance with an embodiment, the need-based routing system 124 allows a user to receive information and locate suppliers of goods and services that can satisfy a particular need. In accordance with an embodiment, each supplier or retailer 108, 116 has a location information 110, 118 associated therewith, and each supplier can maintain its own information 112, 114, including availability and/or cost data about the goods and services provided by that supplier. A goods/services interface 134 allows the system to receive needs-satisfaction information from suppliers and retailers that describes the availability of goods and services at those suppliers and retailers. In accordance with an embodiment, the system comprises a centralized database of goods/services availability and/or cost data 138, which stores information about the goods and services availability at the suppliers and makes that information available via the goods/service interface. When a request or query is received from a user, the NBR logic 132 queries and/or uses the information received from the goods/services interface, together with information received from the digital map to translate a user's need to an offered product or service, and to match and determine availability of goods and/or services to satisfy the users need. As shown in FIG. 3, in accordance with some embodiments the information that describes availability of goods and/or services can be stored in a hierarchical or other database format or taxonomy 139 at the system, such as a listing of office supplies, with multiple subtrees of particular office supply products and then the suppliers that have an available supply of that product. In accordance with various embodiments the system can track both the current and/or an anticipated or future availability of services or products. When a request is received from the user, the NBR logic parses the request to determine the service or produce needed 135, which may include comparing that request to entries in the database 138 to ensure that the request is properly interpreted by the system and will be matched against a valid product or service. When a match is found, the NBR logic can then determine those suppliers that can provide the goods or service, again by reference to the entries in the database. In accordance with other embodiments the information that describes availability of goods and/or services can be stored in an alternative hierarchical or other database format or taxonomy 141, such as a listing of suppliers, with subtrees of the products they provide. In accordance with other embodiments the information that describes availability of goods and/or services need not be stored in a central location, but is distributed over several locations, for example in hierarchical or other database formats or taxonomies at each or several suppliers, and the supplier interfaces are used to allow realtime access by the needs-based routing system to the data stored at those suppliers and in response to a user request. It will be evident that the above variations are just some of the ways in which goods and/or services information can be stored and parsed against a request, and that alternative techniques may be used by one of ordinary skill in the art and within the spirit and scope of the invention.

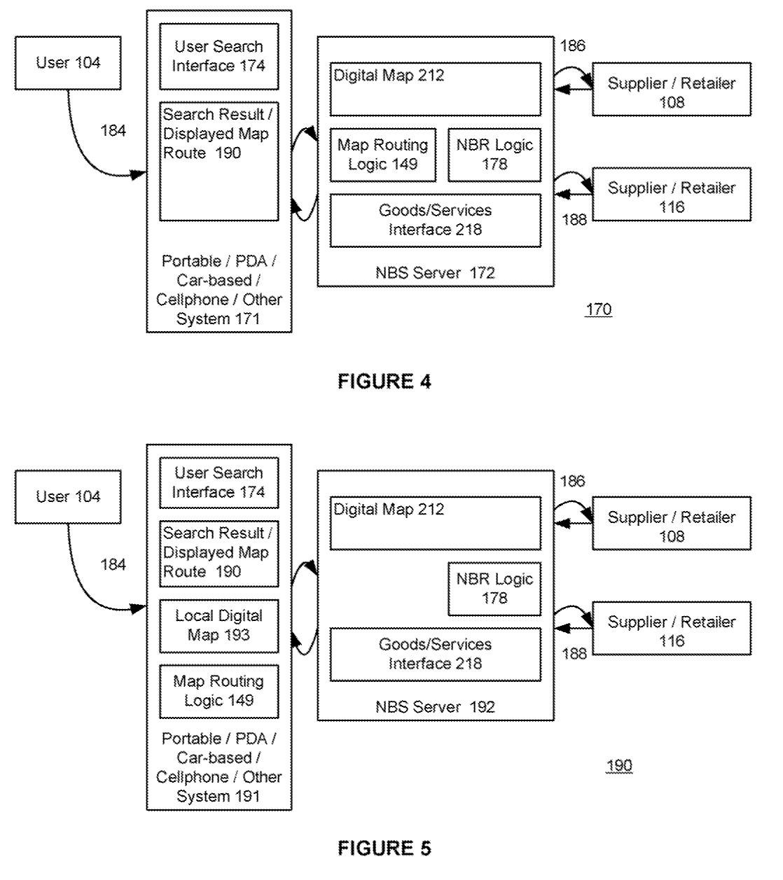

FIG. 4 is an illustration that shows an alternative system for need-based routing in accordance with an embodiment. As shown in FIG. 4, in accordance with an embodiment 170, a need-based routing system 171 that is implemented as a portable, PDA, vehicle-based, cell-phone, or other system implemented as a device, can be used to allow a user 104 to receive information and locate suppliers of goods and services that can satisfy a particular need. Each supplier or retailer 108, 116 can again have location information associated therewith in the form of a lat/long, ULRO, or other type of location-related information. Each supplier can also maintain its own information about the good and services provided by that supplier, and can provide or allow access to a supplier interface which the system uses to receive needs-satisfaction (goods and services availability) information 186, 188 from the supplier, and optionally to provide requests from users for those goods and services. In accordance with an embodiment, the need-based device includes a user search interface 174 for receiving requests from users, a means of displaying a search result or a displayed map route 190 or directions. A need-based (NBS) server 172 comprises a goods/services interface 218 for receiving information from suppliers and retailers as to the availability of goods and services at those suppliers and retailers, a digital map 212, a need-based routing (NBR) logic 178, and a map routing logic 149. The portable, PDA, vehicle-based, cell-phone, or other system implemented as a device can communicate with the server using any means of communication, such as HTTP, Ajax, WAP, or a cellular data connection. When the user uses the device to find information to satisfy a particular need, the NBR logic 178 at the server uses the information received from the goods/services interface, together with information in the digital map (in this example stored on the server) to determine availability of goods and/or services to satisfy the users need, taking into account any geographic or other requirements the user may have specified. The result, including in some embodiments a digital map and/or a displayed map route 190 is then provided to the user. In accordance with an embodiment, the user can optionally request that the system communicate a request to one or more suppliers to hold the goods or services needed by the current user and current request. The system can then communicate with the supplier to update the availability of goods and services for that supplier, to reflect any user-requested hold on those goods or services. Such an embodiment when implemented in a portable, hand-held, in-vehicle, or other manner, allows for dynamic real-time access and ordering of need-based goods and services while the user is on the move.

FIG. 5 is an illustration that shows an alternative system for need-based routing in accordance with an embodiment. As shown in FIG. 5, in accordance with an embodiment 190, a need-based routing system 191 that is implemented as an portable, PDA, vehicle-based, cell-phone, or other system implemented as a device, can include a user search interface 174 for receiving requests from users, a means of displaying a search result or a displayed map route 190 or directions, and a local digital map 193. In this embodiment, the map routing logic can also be included on the device. A need-based (NBS) server 192 comprises a goods/services interface 218 for receiving information from suppliers and retailers as to the availability of goods and services at those suppliers and retailers, a digital map 212 and a need-based routing (NBR) logic 178. When the user uses the device to find information to satisfy a particular need, the NBR logic 178 at the server uses the information received from the goods/services interface to determine availability of goods and/or services to satisfy the users need, taking into account any geographic or other requirements the user may have specified. Data can then be provided to the portable device, and the map routing logic there used to create a digital map and/or a displayed map route 190 which is then provided to the user.

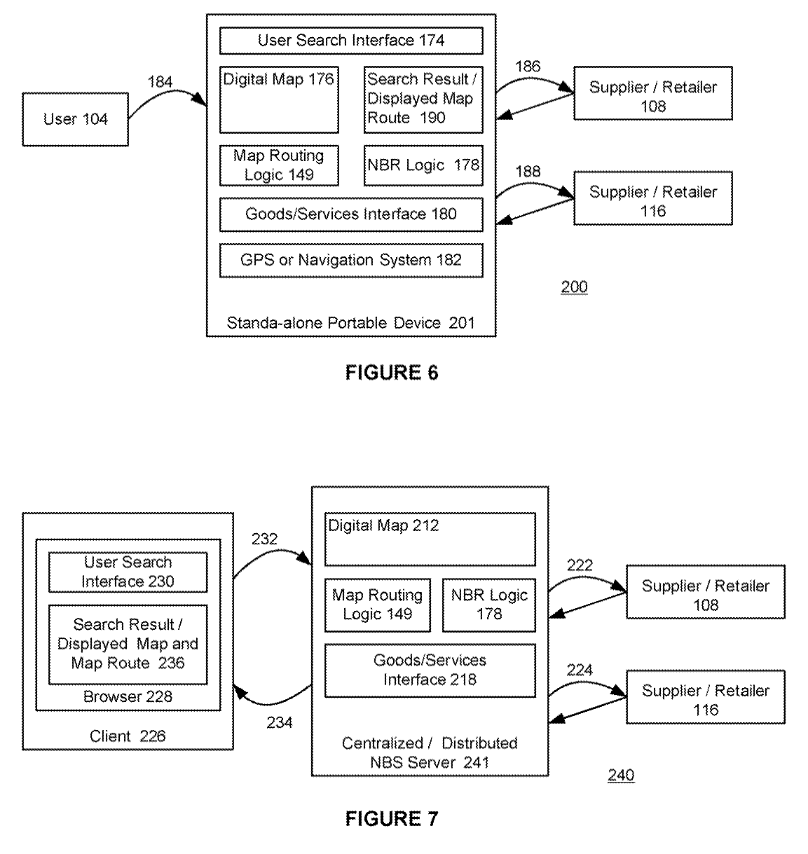

FIG. 6 is an illustration that shows an alternative system for need-based routing in accordance with an embodiment. As shown in FIG. 6, in accordance with an embodiment 200, a need-based routing system can be implemented as a stand-alone portable device 201. Each supplier or retailer 108, 116 can again have location information associated therewith in the form of a lat/long, ULRO, or other type of location-related information. Each supplier can also maintain its own information about the good and services provided by that supplier, and can provide or allow access to a supplier interface which the system uses to receive needs-satisfaction (goods and services availability) information 186, 188 from the supplier, and optionally to provide requests from users for those goods and services. In accordance with an embodiment, the need-based device includes a user search interface 174 for receiving requests from users, and a goods/services interface 180 for receiving information from suppliers and retailers as to the availability of goods and services at those suppliers and retailers. The device further comprises a digital map 176 and a need-based routing (NBR) logic 178. When the user uses the device to find information to satisfy a particular need, the NBR logic 178 uses the information received from the goods/services interface, together with information in the digital map (in this example stored on the device) to determine availability of goods and/or services to satisfy the users need, taking into account any geographic or other requirements the user may have specified, or information from additional components such as a GPS or navigation system 182. The result, including in some embodiments a digital map and/or a displayed map route 190 is then provided to the user. In accordance with an embodiment, the user can optionally request that the system communicate a request to one or more suppliers to hold the goods or services needed by the current user and current request. The system can then communicate with the supplier to update the availability of goods and services for that supplier, to reflect any user-requested hold on those goods or services.

FIG. 7 is an illustration that shows an alternative system for need-based routing in accordance with an embodiment. As shown in FIG. 7, in accordance with an embodiment 240, a need-based routing system can be implemented as a client/server or server-based system 241 to allow a user of a client machine 226 to receive information and locate suppliers of goods and services that can satisfy a particular need. Each supplier or retailer 108, 116 can again have location information associated therewith in the form of a lat/long, ULRO, or other type of location-related information. Each supplier can also maintain its own information about the good and services provided by that supplier, and can provide or allow access to a supplier interface which the system uses to receive needs-satisfaction (goods and services availability) information 222, 224 from the supplier, and optionally to provide requests from users for those goods and services. In accordance with an embodiment, the client includes a browser, for example a Web browser or other application, which allows access to a user search interface 230 such as a Web page. A centralized or distributed need-based (NBS) server 210 comprises a goods/services interface 218 for receiving information from suppliers and retailers as to the availability of goods and services at those suppliers and retailers, a digital map 212 and a need-based routing (NBR) logic 178. The client can communicate with the server using any means of client/server communication, such as HTTP, Ajax, WAP, or a cellular data connection. When the user uses the browser to find information to satisfy a particular need, the NBR logic 178 uses the information received from the goods/services interface, together with information in the digital map (in this example stored on the server) to determine availability of goods and/or services to satisfy the users need, taking into account any geographic or other requirements the user may have specified. The result, including in some embodiments a digital map and/or a displayed map route 236 is then displayed for the user in their browser application. Again, in accordance with an embodiment, the user can optionally request that the system communicate a request to one or more suppliers to hold the goods or services needed by the current user and current request. The system can then communicate with the supplier to update the availability of goods and services for that supplier, to reflect any user-requested hold on those goods or services. Such an embodiment can be implemented in a wide variety of clients without requiring the digital map or NBR logic to be installed on the client, as may be useful in an online or Web-based environment.

The above examples describe various embodiments in which a need-based system can be implemented. It will be evident that the components of the system can also be distributed in a variety of other alternative ways, to suit different applications.

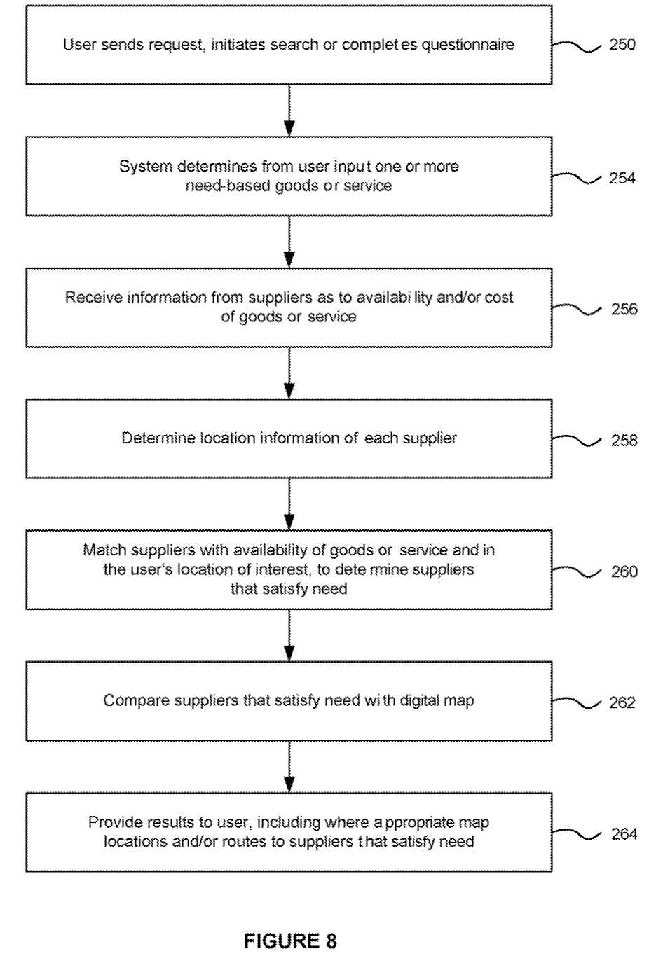

FIG. 8 is a flowchart of a method for need-based routing in accordance with an embodiment. As shown in FIG. 8, in step 250 the user sends a request, initiates a search or completes a questionnaire. This can be through any variety of means including the portable device, browser-based, or online questionnaire means described above. In step 254, the system determines from the user input one or more need-based goods or service. In step 256, the system receives information from suppliers as to the availability and/or costs of goods or services at that supplier. In step 258, the location information of each supplier is determined. In step 260, the system matches suppliers with availability of goods or service and in the user's location of interest, to determine suppliers that satisfy a need of the user. In accordance with some embodiments, a location of interest can be determined by a position determination device, such as a GPS device, that can locate a users' current location. In accordance with other embodiments, a location of interest can be determined by a user or other process determining a location, such as entering a location as input into a search field, or by other means. In step 262, the system can then compare suppliers that satisfy the need with information in the digital map. This can include other map-provided information, such as opening times, traffic restrictions, optimal driving routes, etc. In step 264, the results are provided to the user, including where appropriate map locations and/or routes to suppliers that satisfy their need.

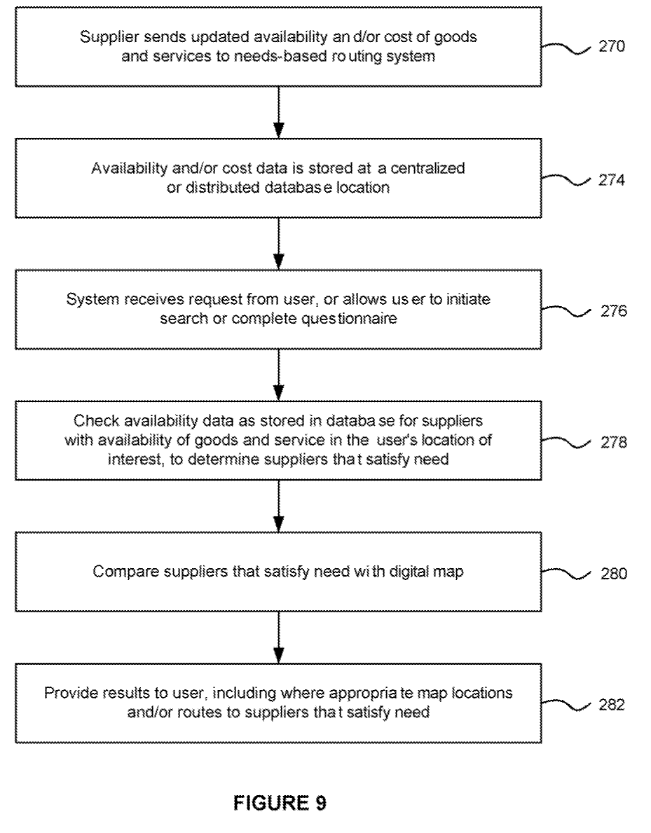

FIG. 9 is a flowchart of an alternative method for need-based routing, which uses a centralized, distributed or static database, in accordance with an embodiment. As shown in FIG. 9, in step 270, each of a plurality of suppliers sends updated availability and/or cost data of goods and services to the need-based routing system. In step 274, availability data is stored at a centralized or distributed database location to reflect the supplier's availability. The database can be stored in a single location, replicated or distributed over several locations, depending on the implementation. In step 276, the system receives a request from user, or allows user to initiate a search or complete a questionnaire, as described above. In step 278, the system checks availability data as stored in the database for suppliers with availability of goods and service in the user's location of interest, to determine suppliers that satisfy a need of the user. In step 280, the system compares suppliers that satisfy the need with the digital map. This can again include other map-provided information, such as opening times, traffic restrictions, and optimal driving routes. In step 282, the results are provided to the user, including where appropriate map locations and/or routes to suppliers that satisfy the user's need.

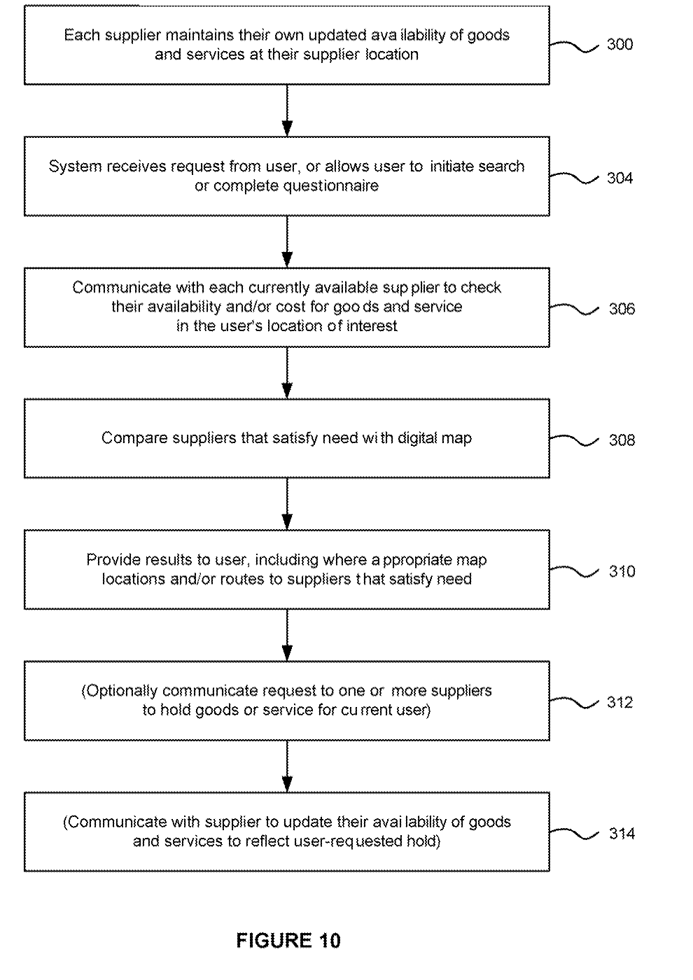

FIG. 10 is a flowchart of an alternative method for need-based routing, which uses dynamic data communication, in accordance with an embodiment. As shown in FIG. 10, in step 300 each supplier maintains their own updated availability and/or cost data of goods and services at their (own) supplier location. In step 304, the system receives a request from user, or allows user to initiate a search or complete a questionnaire. In step 306, the system communicates with each currently available supplier in a dynamic or real-time fashion, to check their availability for goods and service in the user's location of interest. In step 308, the system compares suppliers that satisfy the need with the digital map. In step 310, the system provides results to user, including where appropriate map locations and/or routes to suppliers that satisfy their need. An optional step 312 allows the system to communicate a request to one or more suppliers to hold the goods or services needed by the current user and current request. In step 314 another optional step allows the system to communicate with the supplier to update their availability of goods and services to reflect any user-requested hold on those goods or services.

### Additional Implementations

In accordance with an embodiment, stores and other businesses can publish a static inventory list and/or a dynamic inventory list of what they currently have available (or “in stock”). The dynamic inventory list allows the system to make use of available items in each store location. Stores and/or third party services can provide this information.

In accordance with another embodiment, the system further comprises a method for executing need-based routing, comprising: a computing device capable of receiving and recording user needs, the computing device being further capable of determining the current location, the device being further capable of transmitting said user needs and current location. A needs-based routing logic or database module is capable of receiving the user needs and current location, wherein said needs-based routing logic or database module comprises a database, wherein said needs-based routing logic or database comprises needs-satisfaction information that is used by said database module to compute a set of one or more top locations most likely to satisfy said user need-based on said user needs and said current location. The needs-based routing logic or database module is further capable of transmitting to said computing device said set of one or more top locations, wherein said computing device is further capable of receiving and recording said set of one or more top locations.

In accordance with another embodiment, the computing device is further capable of determining an optimal path from the current location to a top location.

In accordance with another embodiment, the availability and/or the cost of the item is used to determine an optimal supplier and/or route to satisfy the user's need.

In accordance with another embodiment, the computing device is comprised within a vehicle occupied by the user. A database module can also be comprised within the vehicle occupied by the user. In other embodiments, the database module is located remotely relative to the user.

In accordance with another embodiment, the database module and the computing device communicate via a wireless connection. The computing device can be contained within a personal digital assistant (PDA), cellular phone, or other mobile device.

In accordance with another embodiment, the user's location can be determined by a global positioning system (GPS), or by dead reckoning, or by reference to a cellular telephone network, or a combination of these techniques. According to still further embodiments, the user's location can be determined by direct user input.

In accordance with another embodiment, the user's location is described by a geographic marker. The user's location can also be described by a universal location referencing object (ULRO). According to further embodiments, locations are described by geographic markers.

In accordance with another embodiment, access to the database module is obtained via a user subscription.

In accordance with another embodiment, the needs-satisfaction information can be either static (i.e. stored in a central or distributed location and updated on a periodic basis), or dynamic (i.e. generated on the fly, or in real-time in response to a user request).

In accordance with another embodiment, the needs-satisfaction information comprises information about levels of services of said at least one of a service and a product. The needs-satisfaction information comprises information about attributes of said at least one of a service and a product.

In accordance with another embodiment, the needs-satisfaction information comprises information about stock of the product.

In accordance with another embodiment, the needs-satisfaction information comprises information on an available brand of the product of interest.

In accordance with another embodiment, the attributes information comprises information on an available color of the product of interest.

In accordance with another embodiment, the attributes information comprises information on an available size of the product of interest.

In accordance with another embodiment, the attributes information comprises information on the identity of one or more providers of services.

In accordance with another embodiment, the needs are shopping needs, or follow-up user needs submitted subsequent to a first determination of one or more locations.

In accordance with another embodiment, the needs-satisfaction information can be used to provide advertising to the user.

The present invention may be conveniently implemented using a conventional general purpose or a specialized digital computer or microprocessor programmed according to the teachings of the present disclosure. Appropriate software coding can readily be prepared by skilled programmers based on the teachings of the present disclosure, as will be apparent to those skilled in the software art.

In some embodiments, the present invention includes a computer program product which is a storage medium (media) having instructions stored thereon/in which can be used to program a computer to perform any of the processes of the present invention. The storage medium can include, but is not limited to, any type of disk including floppy disks, optical discs, DVD, CD-ROMs, microdrive, and magneto-optical disks, ROMs, RAMs, EPROMs, EEPROMs, DRAMs, VRAMs, flash memory devices, magnetic or optical cards, nanosystems (including molecular memory ICs), or any type of media or device suitable for storing instructions and/or data.

The foregoing description of the present invention has been provided for the purposes of illustration and description. It is not intended to be exhaustive or to limit the invention to the precise forms disclosed. The embodiments were chosen and described in order to best explain the principles of the invention and its practical application, thereby enabling others skilled in the art to understand the invention for various embodiments and with various modifications that are suited to the particular use contemplated. It is intended that the scope of the invention be defined by the following claims and their equivalence.

What is claimed is:

1. A system for need-based routing, comprising:
a computing device capable of receiving and recording user needs, said computing device being further capable of determining a location of interest, said device being further capable of transmitting said user needs and said location of interest;
a needs-based routing logic capable of receiving said user needs and said location, wherein said needs-based routing logic comprises a database, wherein said database comprises needs-satisfaction information, including availability of goods and services at different suppliers, that is used by said needs-based routing logic to translate a need to an offered product or service and to compute a set of one or more top locations most likely to satisfy said user need-based on said user needs and said location, said needs-based routing logic being further capable of transmitting to said computing device said set of one or more top locations; and
wherein said computing device is further capable of receiving and recording said set of one or more top locations.

2. The system of claim 1, wherein said computing device is further capable of determining an optimal path from the location of interest to a top location.

3. The system of claim 1, wherein said computing device is comprised within a vehicle occupied by the user.

4. The system of claim 1, wherein said needs-based routing logic is comprised within a vehicle occupied by the user.

5. The system of claim 1, wherein said needs-based routing logic is located remotely relative to the user.

6. The system of claim 5, wherein said needs-based routing logic and said computing device communicate via a wireless connection.

7. The system of claim 1, wherein said computing device is comprised within a personal digital assistant (PDA).

8. The system of claim 1, wherein said computing device is comprised within cellular phone.

9. The system of claim 1, wherein said user location is determined by a global positioning system (GPS).

10. The system of claim 1, wherein said user location is determined by a dead reckoning device.

11. The system of claim 1, wherein said user location is determined by reference to a cellular telephone network.

12. The system of claim 1, wherein said user location is determined by user input.

13. The system of claim 1, wherein said user location is described by a geographic marker.

14. The system of claim 1, wherein said user location is described by a universal location referencing code (ULRC).

15. The system of claim 1, wherein said top locations are described by geographic markers.

16. The system of claim 1, wherein said top locations are described by geographic markers.

17. The system of claim 5, wherein access to said needs-based routing logic is obtained via a user subscription.

18. The system of claim 1, wherein said needs-satisfaction information is static.

19. The system of claim 1, wherein said needs-satisfaction information is dynamic.

20. The system of claim 1, wherein said needs-satisfaction information comprises information on availability of at least one of a service and a product.

21. The system of claim 1, wherein said needs-satisfaction information comprises information about locations offering at least one of a service and a product.

22. The system of claim 1, wherein said needs-satisfaction information comprises information about cost of said at least one of a service and a product.

23. The system of claim 1, wherein said needs-satisfaction information comprises information about times of availability of said at least one of a service and a product.

24. The system of claim 1, wherein said needs-satisfaction information comprises information about levels of services of said at least one of a service and a product.

25. The system of claim 1, wherein said needs-satisfaction information comprises information about attributes of said at least one of a service and a product.

26. The system of claim 1, wherein said needs-satisfaction information comprises information about stock of said product of interest.

27. The system of claim 1, wherein said needs-satisfaction information comprises information on an available brand of the product of interest.

28. The system of claim 1, wherein said attributes information comprises information on an available color of the product of interest.

25. The system of claim 1, wherein said attributes information comprises information on an available size of the product of interest.

30. The system of claim 1, wherein said attributes information comprises information on the identity of one or more providers of services.

31. The system of claim 1, wherein the needs are shopping needs.

32. The system of claim 1, wherein the user needs are follow up user needs submitted subsequent to a first determination of one or more top locations.

33. The system of claim 1, wherein the needs-satisfaction information is used to provide advertising to the user.

34. A method for need-based routing, comprising the steps of:
providing a computing device capable of receiving and recording user needs, said computing device being further capable of determining a location of interest, said device being further capable of transmitting said user needs and said location of interest;
providing a needs-based routing logic capable of receiving said user needs and said location, wherein said needs-based routing logic comprises a database, wherein said database comprises needs-satisfaction information, including availability of goods and services at different suppliers, that is used by said needs-based routing logic translate a need to an offered product or service and to compute a set of one or more top locations most likely to satisfy said user need-based on said user needs and said location, said needs-based routing logic being further capable of transmitting to said computing device said set of one or more top locations; and
wherein said computing device is further capable of receiving and recording said set of one or more top locations.

35. A computer readable medium including computer readable instructions stored thereon which when read and executed by a computer cause the computer to perform the steps of:
providing a computing device capable of receiving and recording user needs, said computing device being further capable of determining a location of interest, said device being further capable of transmitting said user needs and said location of interest;
providing a needs-based routing logic capable of receiving said user needs and said location, wherein said needs-based routing logic comprises a database, wherein said database comprises needs-satisfaction information, including availability of goods and services at different suppliers, that is used by said needs-based routing logic to translate a need to an offered product or service and compute a set of one or more top locations most likely to satisfy said user need-based on said user needs and said location, said needs-based routing logic being further capable of transmitting to said computing device said set of one or more top locations; and
wherein said computing device is further capable of receiving and recording said set of one or more top locations.
